(19) United States
(12) Patent Application Publication
(10) Pub. No.: US 2012/0171374 A1
(43) Pub. Date: Jul. 5, 2012

(54) NOZZLE FOR USE WITH A SPRAY COATING GUN

(75) Inventors: Eklavya CALLA, Bangalore Karnataka (IN); Yuk-Chiu LAU, Schenectady, NY (US); Surinder Singh PABLA, Greer, SC (US); Viswanathan VENKATACHALAPATHY, Bangalore Karnataka (IN)

(73) Assignee: GENERAL ELECTRIC COMPANY, Schenectady, NY (US)

(21) Appl. No.: 12/983,461

(22) Filed: Jan. 3, 2011

(51) Int. Cl. B05D 1/02; B05C 7/02; B05B 1/34; B05C 5/02; B05B 1/24

(52) U.S. Cl. 427/236; 118/300; 118/302; 118/317; 427/421.1; 427/422

(57) ABSTRACT

A nozzle for use with a spray coating gun for applying a coating material to a substrate. The nozzle includes a discharge portion operative to emit the coating material therefrom. The nozzle also includes a material-receiving portion operative to receive feedstock therein. The discharge portion is angled from the material-receiving portion such that the coating material is discharged from the discharge portion and impacts and bonds with a region of the substrate. The discharge portion can be positioned to apply the coating material in various locations.

### FIELD OF THE INVENTION

The present disclosure is directed to a nozzle for use with a spray coating gun, and in particular, to an angled nozzle for cold spraying particles on surfaces with poor access.

### BACKGROUND OF THE INVENTION

Cold spray coating systems and methods are used to apply various types of coatings to a surface or substrate of an object. For example, a steel mechanical component may be coated with a protective layer of material to prevent corrosion of the mechanical component.

Cold spray methods use a spray gun that receives a high pressure gas such as, for example, helium, nitrogen, and air, and a coating material, such as, for example, metals, refractory metals, alloys, and composite materials in powder form. The powder granules are introduced at pressure into a gas stream in the spray gun and emitted from a nozzle. The gas stream velocity may be supersonic in the nozzle and/or after exiting the nozzle. The particles are accelerated to a high velocity in the gas stream that may reach a supersonic velocity.

The powder impacts the substrate at a high velocity. The kinetic energy of the powder causes the powder granules to deform and flatten on impact with the substrate. The flattening promotes a metallurgical, mechanical, or combination metallurgical and mechanical bond with the substrate and results in a protective coating on the substrate. Advantages of cold spraying methods include the negligible to nil phase change or oxidation of particles during flight and high adhesion strength of the bonded particles.

The spray gun with the converging/diverging nozzle that is used to accelerate the process gas to supersonic velocities is generally cumbersome, measuring 3-10 inches along a cylindrical or rectangular axis. While appropriate for use in many applications, these standard, straight-nozzle spray guns often cannot be used on internal areas and enclosed spaces, e.g., in transition pieces of a gas turbine or cylinders of internal combustion engines, as the nozzle cannot be properly positioned to deposit particles on the surface of the object in these areas of poor access.

Optimum spraying conditions are usually achieved when the high velocity particles impact the substrate as close to right angle as possible. This remains a challenge in smaller enclosed areas as the length of the nozzle does not allow a right angle spray. For e.g. an 8 inch long nozzle will require at least 10 inches of clearance to spray at right angles. Often such clearances are not available in smaller parts. If spraying is done at angle other than an angle which is approximately ninety degrees to the substrate, there is a decrease in the efficiency of the process, as the particles do not bond as effectively to the part or substrate, causing the affected area to have less deposited material.

It would, therefore, be beneficial to provide a spray gun with a nozzle that has the ability to spray locations that have poor access, i.e., in enclosed areas that are not accessible to conventional nozzles.

### SUMMARY OF THE INVENTION

An exemplary embodiment includes a nozzle for applying a coating material to a substrate. The nozzle includes a discharge portion operative to emit the coating material therefrom. The nozzle also includes a material-receiving portion operative to receive feedstock therein. The discharge portion is angled from the material-receiving portion such that coating material is discharged from the discharge portion and impacts and bonds with a region of the substrate. The discharge portion can be positioned to apply the coating material in various locations.

An exemplary embodiment includes a kinetic spray coating gun for applying a coating material to a substrate. The kinetic spray coating gun includes a nozzle having a material-receiving portion and a nozzle discharge portion. The nozzle discharge portion operative to emit the coating material therefrom. A longitudinal axis of the nozzle discharge portion being angled relative to a longitudinal axis of the material-receiving portion such that the coating material impacts and bonds with a region of the substrate. The nozzle discharge opening can be positioned to apply the coating material in various locations.

An exemplary method of applying coating material to a substrate through a kinetic process includes: supplying feedstock to a material-receiving portion of a nozzle; mixing the feedstock to form a coating material; accelerating the coating material; and discharging the coating material from a discharge portion of the nozzle at an angle relative to a longitudinal axis of the material-receiving portion. The nozzle discharge portion can be positioned to apply the coating material to the substrate in various locations.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 illustrates a diagrammatic view of an exemplary embodiment of a kinetic spray system.

FIG. 2 illustrates a schematic side, partially cut-away view of an exemplary embodiment of a spray gun assembly with a first exemplary embodiment of an angled nozzle.

FIG. 3 illustrates a schematic side, partially cut-away view of the exemplary embodiment of the spray gun assembly with a second exemplary embodiment of an angled nozzle.

FIG. 4 illustrates a schematic side, partially cut-away view of the exemplary embodiment of the spray gun assembly with a third exemplary embodiment of an angled nozzle.

FIG. 5 illustrates a schematic side, partially cut-away view of the exemplary embodiment of the spray gun assembly with a fourth exemplary embodiment of an angled nozzle.

FIG. 6 illustrates a schematic side, partially cut-away of the exemplary embodiment of the spray gun assembly with a fifth exemplary embodiment of an angled nozzle, the angled nozzle being movable with respect to the cold spray gun assembly.

FIG. 7 illustrates a diagrammatic view of an exemplary embodiment of a kinetic spray system, shown in solid line, which deposits coating material at approximately a ninety degree angle relative to a substrate, as compared to a prior spray system, shown in broken line, which deposits coating material at an angle that is not approximately ninety degrees.

### DETAILED DESCRIPTION OF THE INVENTION

In the following detailed description, numerous specific details are set forth in order to provide a thorough understanding of various embodiments. However, those skilled in the art will understand that the embodiments may be practiced without these specific details, that the embodiments are not limited to the depicted embodiments, and that the embodiments may be practiced in a variety of alternative embodiments. In other instances, well known methods, procedures, and components have not been described in detail.

Further, various operations may be described as multiple discrete steps performed in a manner that is helpful for understanding the embodiments. However, the order of description should not be construed as to imply that these operations need be performed in the order they are presented, or that they are even order-dependent. Moreover, repeated usage of the phrase “in an embodiment” does not necessarily refer to the same embodiment, although it may. Lastly, the terms “comprising,” “including,” “having,” and the like, as used in the present application, are intended to be synonymous unless otherwise indicated.

The disclosure relates to an article and process of applying cold spray technology to enclosed areas and areas having internal diameters which conventional cold spray nozzles cannot access.

In general, kinetic spray processes, such as cold spray process for depositing powder materials, such as, but not limited to, metal, alloy, cermet, or composite materials onto a surface or substrate are advantageous in that they provide sufficient energy to accelerate particles to high enough velocities such that, upon impact, the particles plastically deform and bond to the surface or onto a previously deposited layer. The process allows the build-up of a relatively dense coating or structural deposit.

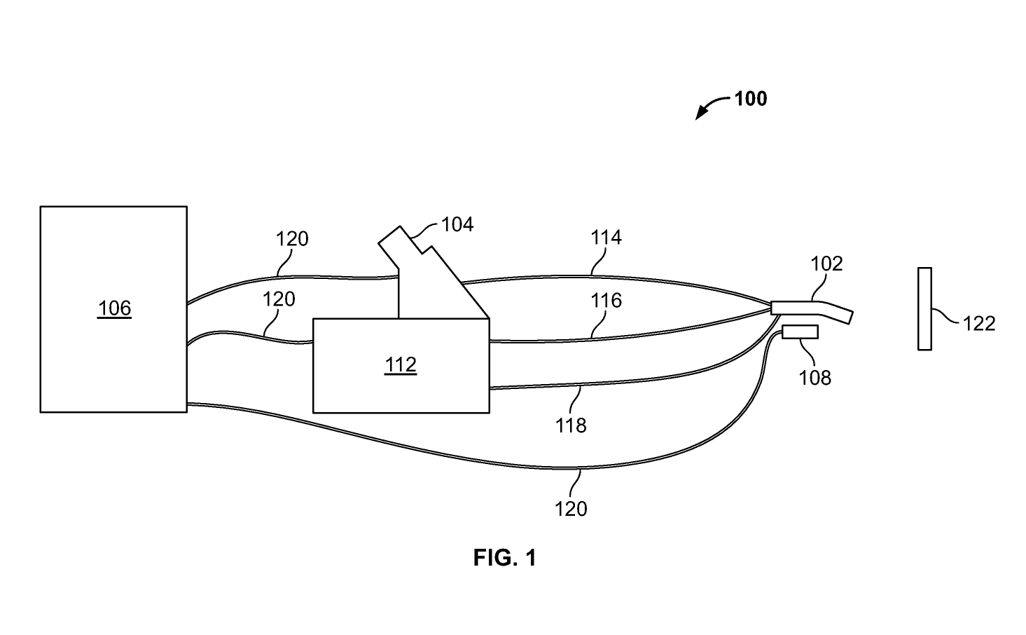

Kinetic systems use a kinetic spray gun to apply a coating to a surface of an object (substrate). FIG. 1 illustrates an exemplary embodiment of one type of kinetic system, a cold spray system 100. The system 100 includes a spray gun 102, a powder feeder 104 and a control unit 106. A heat source 108, such as, for example, lasers and heating elements, may be provided, but is not required. The system 100 may also include a gas heater 112. The spray gun 102 is connected to the powder feeder 104 via a powder line 114, and is connected to the gas heater 112 via a gas line 116. A sensor line 118 may communicatively connect temperature and pressure sensors (not shown) in the spray gun 102 to the control unit 106. Control lines 120 may communicatively connect the control unit 106 to the gas heater 112, the powder feeder 104, the heat source 108, and the sensors in the spray gun 102.

In operation, the spray gun 102 receives pressurized gas from a gas source via the gas heater 112. The gas heater 112 heats the gas to a temperature of up to 1000 degrees Celsius, but usually to a temperature of less than 600 degrees Celsius. In alternate embodiments, the gas heater 112 may be bypassed, resulting in the pressurized gas not being heated. Feedstock, such as, but not limited to, coating material or powderized coating material is supplied under pressure to the spray gun 102 via the powder line 114. The coating material is introduced into a stream of gas internally in the spray gun 102. The coating material may be fed in a convergent or divergent region of the spray gun 102. The stream of expanding gas and coating material exits a divergent region of a nozzle in the spray gun 102. When the coating material impacts an object (substrate) 122, granules in the coating material flatten and deform to form a coating on the substrate 122. The control unit 106 controls the process—including, for example, the gas heater 112 and the powder feeder 104—and receives pressure and temperature readings from the spray gun sensors.

The optional heat source 108 may include one or more lasers or other type of heat source such as, for example, a heating element. For illustrative purposes, the embodiment includes a laser unit as the heat source 108. The lasers emit a beam of laser light (not shown). The beam of laser light may be used to pre-heat a region of the substrate 122 prior to the application of the coating material. Pre-heating a region of the substrate 122 prior to the application of the coating material may be desirable to improve the performance and properties of the applied coating. The pre-heating may also be used to heat coated regions of the substrate prior to the application of additional coats of coating material. The laser may also be used to anneal the deposits, substrate and/or the combination thereof.

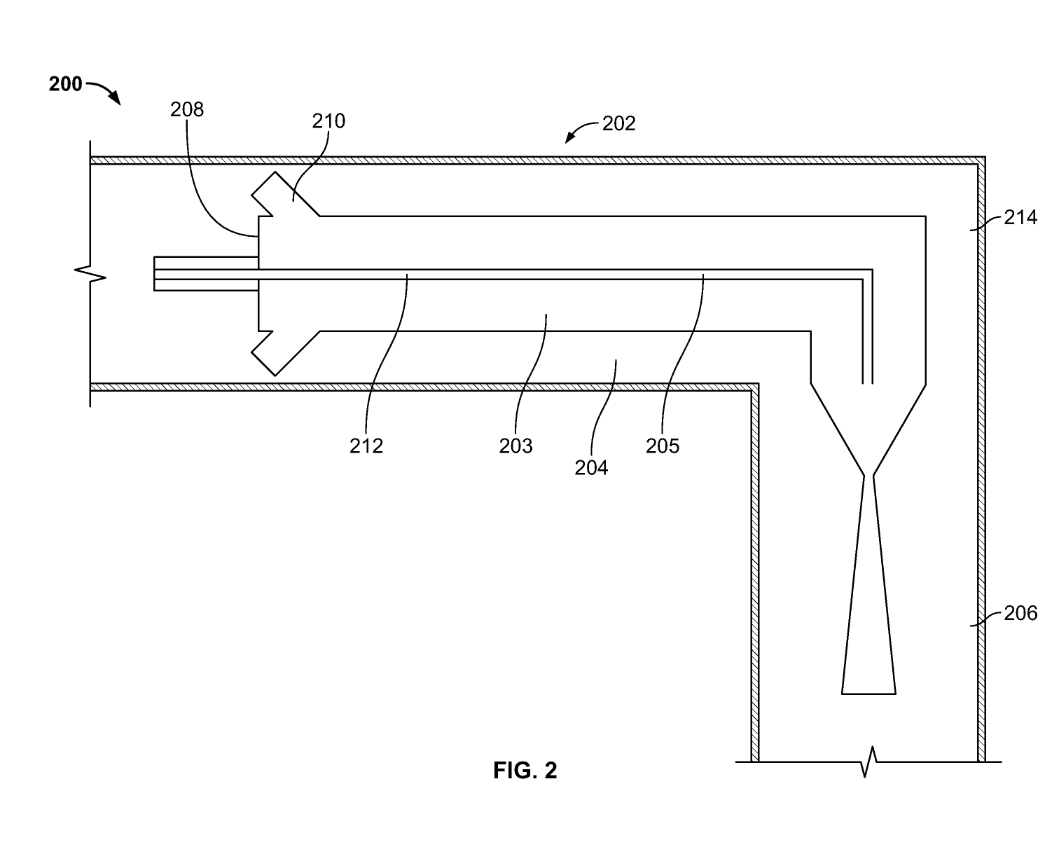

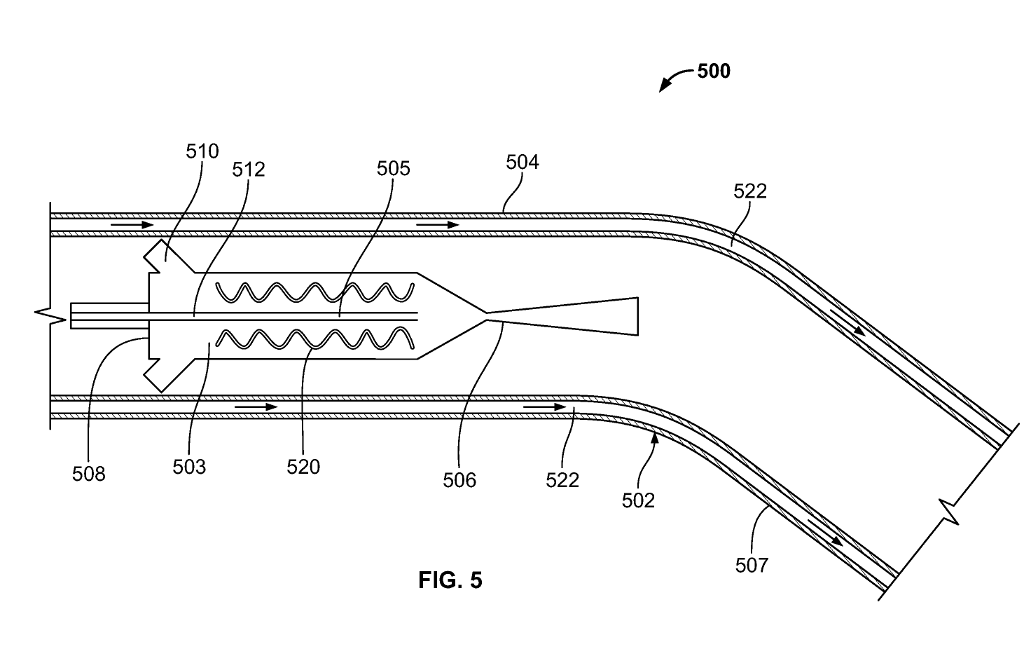

FIG. 2 illustrates a side, partially cut-away view of an exemplary embodiment of a spray gun assembly 200 having nozzle 202. The nozzle 202 has a material-receiving portion or extension portion 204 and a discharge portion or converging/diverging portion 206. In the embodiment shown in FIG. 2, the extension portion 204 extends from a pre-chamber 203 of a main body portion 208 of the assembly 200, such that the extension portion 204 receives process gas via the process inlet 210 and coating material via the powder inlet 212. As shown in FIG. 5, a feeder tube 205 extends from the power inlet 212 directly to the converging portion of the converging/diverging portion 206. Alternatively, the feeder tube 205 may extend into the diverging portion. The converging/diverging portion 206 extends from an angle portion or bend 214 which is attached to the extension portion 204, such that the longitudinal axis of the converging/diverging portion 206 is angled relative to the longitudinal axis of the extension portion 204.

The angle or bend 214 allows the nozzle 202 to be used to apply the cold spray to internal areas and enclosed spaces, e.g., in transition piece of gas turbines, cylinders of IC engines, etc. While the embodiment shown in FIG. 2 has an angle or bend of 90 degrees, the angle or bend 214 can range between approximately 0 degrees to approximately 180 degrees, more specifically between approximately 30 degrees to approximately 150 degrees, even more specifically between approximately 60 degrees to approximately 120 degrees, and even more specifically between approximately 75 degrees to approximately 105 degrees with respect to the longitudinal axis of the extension portion 204. The nozzle 202 can, therefore, be positioned to spray in locations that may be in enclosed areas that are not accessible to conventional, straight nozzles, which do not have an angle on the spraying side. By angling the converging/diverging portion 206 relative to the extension portion 204, the converging/diverging portion 206 can be positioned such that the coating material impacts the substrate at approximately ninety degrees, as is shown in FIG. 7 by the gun 102 shown in solid line. This is of benefit at various locations on the substrate, including in smaller enclosed areas where the length of the nozzle 202 may exceed the clearance provided by an opening in the substrate. In such enclosed or confined areas, without the bend, the end of the nozzle would be provided at an angle other than an angle which is approximately ninety degrees to the substrate (as is shown in FIG. 7 by the gun 102 shown in broken line), thereby decreasing the efficiency of the spray gun, as the coating material would not bond as effectively to the substrate, causing the affected area to have less deposited material.

The extension portion 204 may be integral with the converging/diverging portion 206 and the angle or bend 214, forming a unitary, single-piece nozzle 202 where the nozzle bends towards the spraying side. Alternatively, the extension portion 204 and/or bend 214 and/or converging/diverging portion 206 may be formed as separate pieces and joined together in any known manner. Additionally, the angle or bend 214 may be a single piece or multiple pieces to form the angle required. The nozzles 202 can be either cylindrical or rectangular, or have any other cross-sectional shape, so long as the coating material is properly accelerated.

In operation, the spray gun assembly 200 receives process gas via a process inlet 210 and coating material via a granule or powder inlet 212. The coating material is introduced to the process gas in the extension portion 204 of the nozzle 202. Alternatively, the coating material may also be introduced in the diverging portion of the nozzle 202, thereby allowing the use of a lower pressure powder feed device as the back pressure in the diverging portion is lower than that prevailing upstream. The mixture of the stream of gas and granules or particles or the coating material and the process gas is moved through the converging/diverging portion 206. The coating material and the process gas exit the converging/diverging portion 206 and the nozzle 202 at an accelerated rate and the granules are deposited on the substrate or surface of the article. The nozzle 202 can be positioned to spray in locations that may be in enclosed areas that are not accessible to conventional, straight nozzles, which do not have an angle on the spraying side.

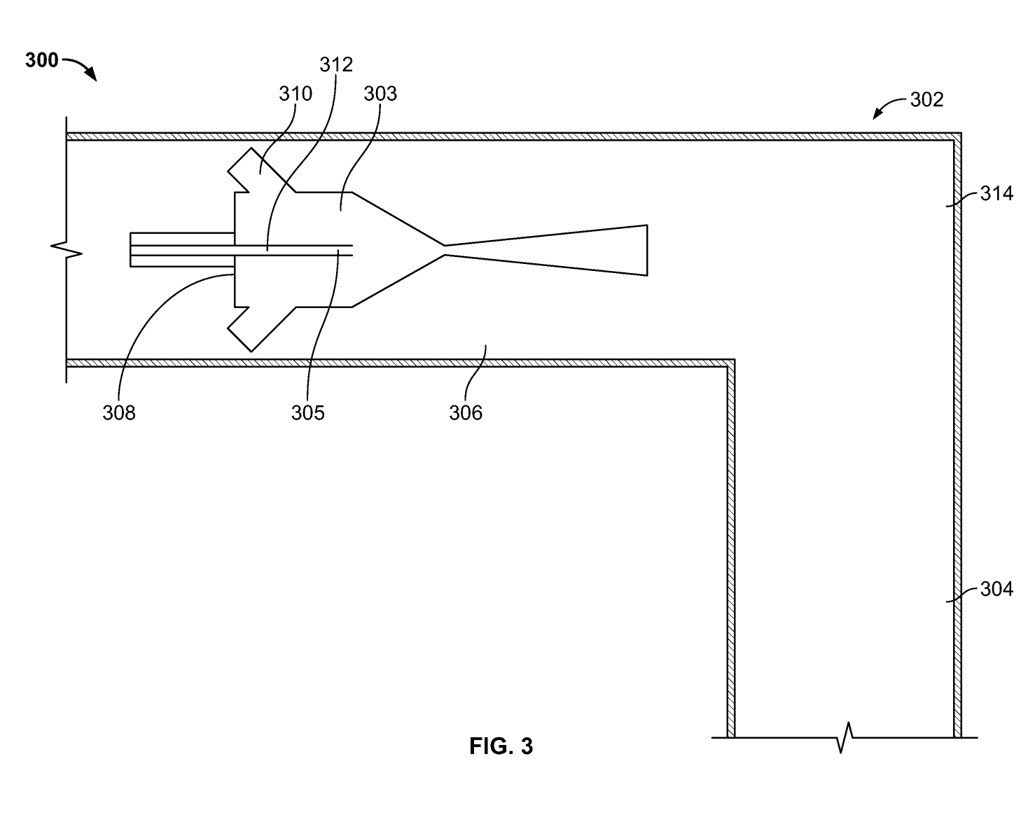

FIG. 3 illustrates a side, partially cut-away view of an alternate exemplary embodiment of a spray gun assembly 300 having nozzle 302. The nozzle 302 has a material-receiving portion or converging/diverging portion 306 and a discharge portion or extension portion 304. In the embodiment shown in FIG. 3, the converging/diverging portion 306 extends from a pre-chamber 303 of a main body portion 308 of the assembly 300, such that the converging/diverging portion 306 receives process gas via the process inlet 310 and coating material via the powder inlet 312. As shown in FIG. 3, a feeder tube 305 extends from the power inlet 312 directly to the converging portion of the converging/diverging portion 306. Alternatively, the feeder tube 305 may extend into the diverging portion. The extension portion 304 extends from an angle portion or bend 314 which is attached to the converging/diverging portion 306, such that the longitudinal axis of the extension portion 304 is angled relative to the longitudinal axis of the converging/diverging portion 306.

The angle or bend 314 allows the nozzle 302 to be used to apply the cold spray to internal areas and enclosed spaces, e.g., in transition piece of gas turbines, cylinders of IC engines, etc. While the embodiment shown in FIG. 3 has an angle or bend of 90 degrees, the angle or bend 314 can range between approximately 0 degrees to approximately 180 degrees, more specifically between approximately 30 degrees to approximately 150 degrees, even more specifically between approximately 60 degrees to approximately 120 degrees, and even more specifically between approximately 75 degrees to approximately 105 degrees with respect to the longitudinal axis of the converging/diverging portion 306. The nozzle 302 can, therefore, be positioned to spray in locations that may be in enclosed areas that are not accessible to conventional, straight nozzles, which do not have an angle on the spraying side. By angling the extension portion 304 relative to the converging/diverging portion 306, the extension portion 304 can be positioned such that the coating material impacts the substrate at approximately ninety degrees. This is of benefit at various locations on the substrate, including in smaller enclosed areas where the length of the nozzle 302 may exceed the clearance provided by an opening in the substrate. In such enclosed or confined areas, without the bend, the end of the nozzle must be provided at an angle other than an angle which is approximately ninety degrees to the substrate, thereby decreasing in the efficiency of the spray gun 300, as the coating material will not bond as effectively to the substrate, causing the affected area to have less deposited material.

The converging/diverging portion 306 may be integral with the extension portion 304 and the angle or bend 314, forming a unitary, single-piece nozzle 302 where the nozzle bends towards the spraying side. Alternatively, the converging/diverging portion 306 and/or bend 314 and/or extension portion 304 may be formed as separate pieces and joined together in any known manner. Additionally, the angle or bend 314 may be a single piece or multiple pieces to form the angle required. The nozzles 302 can be either cylindrical or rectangular, or have any other cross-sectional shape, so long as the coating material is properly accelerated.

In operation, the spray gun assembly 300 receives process gas via a process inlet 310 and coating material via a powder inlet 312. The coating material is introduced to the process gas in the converging/diverging portion 306 of the nozzle 302 and accelerated therein. The mixture of the granules of the coating material and the process gas is moved through the extension portion 304. The coating material and the process gas exit the extension portion 304 and the nozzle 302, and the granules are deposited onto the substrate or surface of the article. The nozzle 302 can be positioned to spray in locations that may be in enclosed areas that are not accessible to conventional, straight nozzles, which do not have an angle on the spraying side.

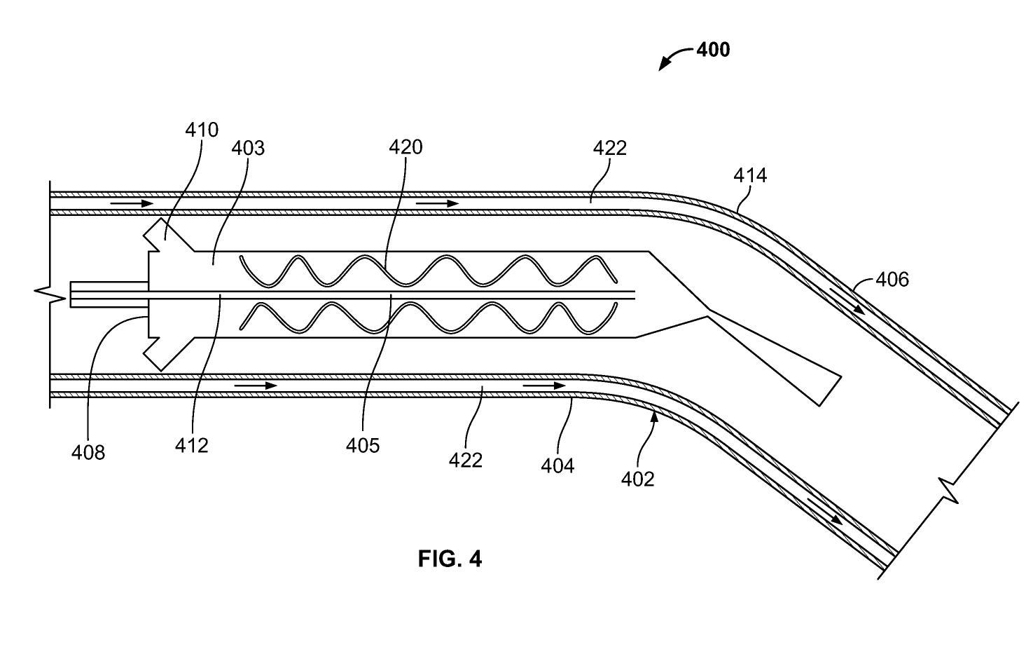

FIG. 4 illustrates a side, partially cut-away view of another exemplary embodiment of a spray gun assembly 400 having nozzle 402. The nozzle 402 has a material-receiving or extension portion 404 and a discharge or converging/diverging portion 406. In the embodiment shown in FIG. 4, the extension portion 404 extends from a pre-chamber 403 of a main body portion 408 of the assembly 400, such that the extension portion 404 receives process gas via the process inlet 410 and coating material via the powder inlet 412. As shown in FIG. 4, a feeder tube 405 extends from the power inlet 412 directly to the converging portion of the converging/diverging portion 406. Alternatively, the feeder tube 405 may extend into the diverging portion. The converging/diverging portion 406 extends from an angle portion or bend 414 which is attached to the extension portion 404, such that the longitudinal axis of the converging/diverging portion 406 is angled relative to the longitudinal axis of the extension portion 404.

In this embodiment, inline gas heaters 420 may provided in the extension portion 404 to heat the process gas. An air inlet 422 is provided about the perimeter of the converging/diverging portion 406 and the extension portion 404, the air inlet 422 provides air to cool the substrate and the coating material when it is applied to the substrate.

The angle or bend 414 allows the nozzle 402 to be used to apply the cold spray to internal areas and enclosed spaces, e.g. in transition piece of gas turbines, cylinders of IC engines etc. While the embodiment shown in FIG. 4 has an angle or bend of approximately 45 degrees, the angle or bend 414 can range between approximately 0 degrees to approximately 180 degrees, more specifically between approximately 30 degrees to approximately 150 degrees, even more specifically between approximately 60 degrees to approximately 120 degrees, and even more specifically between approximately 75 degrees to approximately 105 degrees with respect to the longitudinal axis of the extension portion 404. The nozzle 402 can, therefore, be positioned to spray in locations that may be in enclosed areas that are not accessible to conventional, straight nozzles, which do not have an angle on the spraying side. By angling the converging/diverging portion 406 relative to the extension portion 404, the converging/diverging portion 406 can be positioned such that the coating material impacts the substrate at approximately ninety degrees. This is of benefit at various locations on the substrate, including in smaller enclosed areas where the length of the nozzle 402 may exceed the clearance provided by an opening in the substrate. In such enclosed or confined areas, without the bend, the end of the nozzle would be provided at an angle other than an angle which is approximately ninety degrees to the substrate, thereby decreasing the efficiency of the spray gun, as the coating material would not bond as effectively to the substrate, causing the affected area to have less deposited material.

The nozzle may be formed in one piece to include the process inlet 410 and the powder inlet 412. Alternatively, the nozzle 402 may be enclosed in a sheath or the nozzle 402 may include tubular sections throughout the length to form process gas and powder feed channels. The nozzles 402 can be either cylindrical or rectangular, or have any other cross-sectional shape, so long as the coating material is properly accelerated.

In operation, the spray gun assembly 400 receives process gas via a process inlet 410 and coating material via a powder inlet 412. The coating material is introduced to the process gas in the extension portion 404 of the nozzle 402 and heated by heaters 420. The mixture of the coating material and the process gas is moved through the converging/diverging portion 406. The coating material and the process gas exit the converging/diverging portion 406 and the nozzle 402 at an accelerated rate, and the granules of the coating material are deposited onto the substrate or surface of the article. Air is supplied through the air inlet 422 of the nozzle 402 to cool the substrate and the coating material. The nozzle 402 can be positioned to spray in locations that may be in enclosed areas that are not accessible to conventional, straight nozzles, which do not have an angle on the spraying side.

FIG. 5 illustrates a side, partially cut-away view of another exemplary embodiment of a spray gun assembly 500 having nozzle 502. The nozzle 502 has a material-receiving portion or first extension portion 504, a converging/diverging portion 506 and a discharge portion or second extension portion 507. In the embodiment shown in FIG. 5, the first extension portion 504 extends from a pre-chamber 503 of a main body portion 508 of the assembly 500, such that the first extension portion 504 receives process gas via the process inlet 510 and coating material via the powder inlet 512. As shown in FIG. 5, a feeder tube 505 extends from the power inlet 512 directly to the converging portion of the converging/diverging portion 506. Alternatively, the feeder tube 505 may extend into the diverging portion. The converging/diverging portion 506 extends from the first extension portion 504. The longitudinal axis of the first extension portion 504 and the converging/diverging portion 506 are essentially aligned. The second extension portion 507 extends from an angle portion or bend 514 attached to the converging/diverging portion 506, such that the longitudinal axis of the second extension portion 507 is angled relative to the longitudinal axis of the converging/diverging portion 506.

In this embodiment, inline gas heaters 520 are provided in the first extension portion 504 to heat the process gas. An air inlet 522 is provided about the perimeter of the first extension portion 504, the converging/diverging portion 506 and the second extension portion 507, the air inlet 522 providing air to cool the substrate and the coating material when it is applied to the substrate. Substrate/coating cooling may be required in some situations where the process gas is heated and the process requirement is to keep the substrate/coating temperature low.

The angle or bend 514 allows the nozzle 502 to be used to apply the cold spray to internal areas and enclosed spaces, e.g., in transition piece of gas turbines, cylinders of IC engines, etc. While the embodiment shown in FIG. 5 has an angle or bend of approximately 45 degrees, the angle or bend 514 can range between approximately 0 degrees to approximately 180 degrees, more specifically between approximately 30 degrees to approximately 150 degrees, even more specifically between approximately 60 degrees to approximately 120 degrees, and even more specifically between approximately 75 degrees to approximately 105 degrees with respect to the longitudinal axis of the extension portion 504. The nozzle 502 can, therefore, be positioned to spray in locations that may be in enclosed areas that are not accessible to conventional, straight nozzles, which do not have an angle on the spraying side. By angling the second extension portion 507 relative to the converging/diverging portion 506, the second extension portion 507 can be positioned such that the coating material impacts the substrate at approximately ninety degrees. This is of benefit at various locations on the substrate, including in smaller enclosed areas where the length of the nozzle 502 may exceed the clearance provided by an opening in the substrate. In such enclosed or confined areas, without the bend, the end of the nozzle would be provided at an angle other than an angle which is approximately ninety degrees to the substrate, thereby decreasing the efficiency of the spray gun, as the coating material would not bond as effectively to the substrate, causing the affected area to have less deposited material.

The nozzle may be formed in one piece to include the process inlet 510 and the powder inlet 512. Alternatively, the nozzle 502 may be enclosed in a sheath or the nozzle 502 may include tubular sections throughout the length to form process gas and powder feed channels. The nozzles 502 can be either cylindrical or rectangular, or have any other cross-sectional shape, so long as the coating material is properly accelerated.

In operation, the spray gun assembly 500 receives process gas via a process inlet 510 and coating material via a powder inlet 512. The coating material is introduced to the process gas in the first extension portion 504 of the nozzle 502 and heated by heaters 520. The coating material is introduced to the process gas in the converging/diverging portion 506 of the nozzle 502 and accelerated therein. The mixture of the coating material and the process gas is moved through the extension portion 504. The coating material and the process gas exit the second extension portion 507 and the nozzle 502, and the granules of the coating mixture are deposited onto the substrate or surface of the article. Air is supplied through the air inlet 522 of the nozzle 502 to cool the substrate and the coating material. The nozzle 502 can be positioned to spray in locations that may be in enclosed areas that are not accessible to conventional, straight nozzles, which do not have an angle on the spraying side.

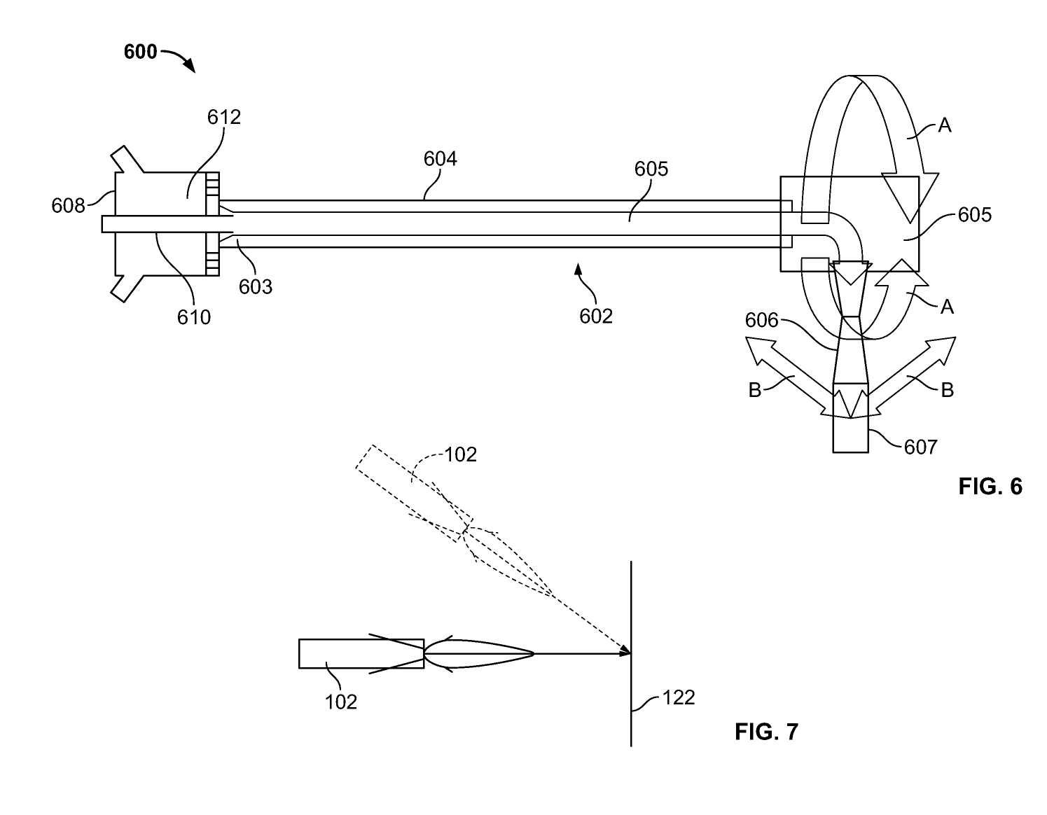

FIG. 6 illustrates a side, partially cut-away view of another exemplary embodiment of a spray gun assembly 600 having nozzle 602. The nozzle 602 has a material-receiving portion or extension portion 604, a rotating portion 605 and a discharge portion or converging/diverging portion 606. In the embodiment shown in FIG. 6, the extension portion 604 extends from a pre-chamber 603 of a main body portion 608 of the assembly 600, such that the extension portion 604 receives process gas via the process inlet 610 and coating material via the powder inlet 612. Alternatively, the process inlet and powder inlet may be fed directly into the extension portion 604, allowing the extension portion 604 to act as the pre-chamber. The rotating portion or collar 605 extends from the extension portion 604. The converging/diverging portion 606 extends from the rotating portion 605. The converging/diverging portion 606 extends at an angle or bend relative to the extension portion 604. The rotating portion 605 is mounted to the extension portion 604 such that the rotating portion 605 can be rotated independently in a complete circular rotation or 360 degrees, more specifically between 180 degrees, even more specifically 60 degrees, and even more specifically between approximately 30 degrees, relative to the extension portion 604 (as indicated by arrows A) by a spoolie/collar arrangement or by other known arrangements. The converging/diverging portion 606 is mounted to the rotating portion 605 using known methods. The converging/diverging portion 606 may be fixedly mounted to the rotating portion 605 or may be pivotally mounted thereto to allow the converging/diverging portion 606 to pivot relative to the rotating portion 605. In the embodiment shown, a second extension portion 607 extends from the converging/diverging portion 606. The second extension portion 607 may be fixedly mounted to the converging/diverging portion 606 or may be pivotally mounted thereto to allow the second extension portion 607 to pivot relative to the converging/diverging portion 606 (as indicated by arrows B).

The relative movement of the components of the nozzle 602 allows the nozzle 602 to be used to apply the cold spray to internal areas and enclosed spaces, e.g., in transition piece of gas turbines, cylinders of IC engines, etc. While the embodiment shown in FIG. 6 shows the converging/diverging portion 606 at an angle of 90 degrees relative to the extension portion 604, the angle can range between approximately 0 degrees to approximately 180 degrees, more specifically between approximately 30 degrees to approximately 150 degrees, even more specifically between approximately 60 degrees to approximately 120 degrees, and even more specifically between approximately 75 degrees to approximately 105 degrees, with respect to the longitudinal axis of the extension portion 604. The nozzle 602 can, therefore, be positioned to spray in locations that may be in enclosed areas that are not accessible to conventional, straight nozzles, which do not have an angle on the spraying side. The nozzles 602 can be either cylindrical or rectangular, or have any other cross-sectional shape, so long as the coating material is properly accelerated. By allowing the converging/diverging portion 606 to move, the converging/diverging portion can be positioned such that the coating material impacts the substrate at approximately ninety degrees. This is of benefit at various locations on the substrate, including in smaller enclosed areas where the length of the nozzle 602 may exceed the clearance provided by an opening in the substrate. In such enclosed or confined areas, without the rotating portion 605, the end of the nozzle would be provided at an angle other than an angle which is approximately ninety degrees to the substrate, thereby decreasing the efficiency of the spray gun, as the coating material would not bond as effectively to the substrate, causing the affected area to have less deposited material.

In operation, the spray gun assembly 600 receives process gas via a process inlet 610 and coating material via a powder inlet 612. The coating material is introduced to the process gas in the extension portion 604 of the nozzle 602. The process gas is moved through the rotating portion 605 and the converging/diverging portion 606. The coating material is injected into the gas stream via a feeder tube 605 in the converging portion of the diverging portion. The coating material and the process gas exit the converging/diverging portion 606 and the nozzle 602 at an accelerated rate, and the coating material is deposited onto the substrate or surface of the article. The nozzle 602 can be positioned to spray in locations that may be in enclosed areas that are not accessible to conventional, straight nozzles, which do not have an angle on the spraying side.

While FIG. 6 illustrates a nozzle in which the converging/diverging portion is positioned after the rotating portion, the converging/diverging portion may be positioned in other locations, including prior to the rotating portion. In addition, the nozzle illustrated in FIG. 6 may include inline heaters, air inlets and other features.

In any of the embodiments, the nozzles may include temperature and pressure sensor connections and tubing to carry the cables for such sensor connections. Sensors may be attached to the sensor connections, which may be located at various positions in the nozzle to enable appropriate temperature and pressure measurements.

An extension attachment may be provided at the end of the nozzle. The attachment may be made as long as the part requires, such as length of 2 meters, more specifically 1 meter, and even more specifically 0.5 meters. This will facilitate to coating of long tubular parts. The flow of the coating material through the attachment would create a laminar effect in the flow. In one embodiment, an extension attachment may be attached to the discharge end, such that the extension attachment can be rotated along the radial axis of the discharge end to allow the coating material to be deposited as desired.

The nozzles and method for use with a kinetic spray gun described and claimed herein, allows for the coating material to be applied to surfaces in enclosed areas, internal areas of components, and other areas which are difficult to reach using known nozzles. This allows the surfaces or substrates to be uniformly coated using cold spray technology. Benefits of such coatings include, but are not limited to, improvement in the life of the components and permitting the use of higher temperatures in turbines. In addition, lower quality fuel [and high moisture fuels] could also be used if suitable coatings can be applied to mitigate corrosion and erosion issues arising from using lower quality fuel.

While the written description has referred to a preferred embodiment, it will be understood by those skilled in the art that various changes and modifications may be made and equivalents may be substituted for elements thereof without departing from the patentable scope as defined by the claims. Therefore, it is intended that the patentable scope not be limited to the particular embodiments disclosed as the best mode contemplated, but rather other embodiments are intended to be within the scope of the claims if they have structural elements that do not differ from the literal language of the claims, or if they include equivalent structural elements with insubstantial differences from the literal language of the claims.

1. A nozzle for applying a coating material to a substrate, the nozzle comprising:
a discharge portion operative to emit coating material therefrom;
a material-receiving portion operative to receive feedstock therein;
the discharge portion being angled from the material-receiving portion such that the coating material is discharged from the discharge portion and impacts and bonds with a region of the substrate;
whereby the discharge portion can be positioned to apply the coating material in various locations.

2. The nozzle as recited in claim 1, wherein the nozzle has the material-receiving portion, an angle portion, and the discharge portion.

3. The nozzle as recited in claim 2, wherein the material-receiving portion has a convergent/divergent section which accelerates the coating material.

4. The nozzle as recited in claim 2, wherein the discharge portion has a convergent/divergent section which accelerates the coating material.

5. The nozzle as recited in claim 2, wherein a longitudinal axis of the discharge portion is angled from about 0 to about 180 degrees relative to a longitudinal axis of the material-receiving portion.

6. The nozzle as recited in claim 2, wherein the nozzle has inline heaters provided therein to heat the gas which travels therethrough.

7. The nozzle as recited in claim 2, wherein the nozzle has air inlets provided therein, whereby the air inlets provide air to cool the substrate upon which the coating material is applied.

8. The nozzle as recited in claim 2, wherein an attachment is provided on the discharge portion, the flow of the coating material through the attachment creating a laminar effect.

9. The nozzle as recited in claim 1, wherein the nozzle has the material-receiving portion, a rotating portion, and the discharge portion.

10. The nozzle as recited in claim 9, wherein the rotating portion and the discharge portion can rotate between 0 and 360 degrees relative to the longitudinal axis of the material-receiving portion.

11. The nozzle as recited in claim 9, wherein the discharge portion is pivotally attached to the rotating portion, whereby the discharge portion of the nozzle may be positioned in enclosed areas of the substrate.

12. The nozzle as recited in claim 1, wherein an extension attachment is attached to the discharge portion, the extension attachment is able to be rotated along the radial axis of the discharge portion, whereby the coating material may be deposited as desired.

13. The nozzle as recited in claim 1, wherein the nozzle has one or more sensor connections provided therein.

14. A method of applying coating material to a substrate through a kinetic process, the method comprising:
supplying a feedstock to a material-receiving portion of a nozzle;
mixing the feedstock to form a coating material;
accelerating the coating material; and
discharging the coating material from a discharge portion of the nozzle at an angle relative to a longitudinal axis of the material-receiving portion;
whereby the nozzle discharge portion can be positioned to apply the coating material in various locations of the substrate.

15. The method as recited in claim 14, further comprising:
accelerating the coating material prior to a bend in the nozzle.

16. The method as recited in claim 14, further comprising:
accelerating the coating after a bend in the nozzle.

17. The method as recited in claim 14, further comprising:
heating the stream of gas in the nozzle.

18. The method as recited in claim 14, further comprising:
rotating the discharge portion of the nozzle relative to the material-receiving portion, whereby the discharge portion of the nozzle may be positioned in enclosed areas of the substrate.

19. The method as recited in claim 14, further comprising:
attaching an attachment to the discharge portion of the nozzle; and
rotating the attachment relative to the discharged portion of the nozzle;
whereby the attachment may be positioned in enclosed areas of the substrate.

20. A kinetic spray coating gun for applying a coating material to a substrate, the kinetic spray coating gun comprising:
a nozzle having a material-receiving portion and a nozzle discharge portion, the nozzle discharge portion operative to emit the coating material therefrom, a longitudinal axis of the nozzle discharge portion being angled relative to a longitudinal axis of the material-receiving portion such that the coating material impacts and bonds with a region of the substrate;
whereby the discharge portion can be positioned to apply the coating material in various locations of the substrate.
